(19) United States
(12) Patent Application Publication
(10) Pub. No.: US 2002/0001315 A1
(43) Pub. Date: Jan. 3, 2002

(54) Method and apparatus for compressing IP/UDP/RTP headers in a lossy environment

(76) Inventors: Hung V. Tran, Dallas, TX (US); Erika C. Schnurr, Richardson, TX (US); Martin Gallant, Garland, TX (US)

Correspondence Address: Garlick & Harrison, P.O. Box 670007, Dallas, TX, 75367, US

(21) Appl. No.: 09/751,465

(22) Filed: Dec. 29, 2000

Related U.S. Application Data
(60) Provisional application No. 60/191,002, filed on Mar. 21, 2000.

(51) Int. Cl. H04L 12/56

(52) U.S. Cl. 370/475; 370/477; 370/389

(57) ABSTRACT

A system and method for compressing data packet headers in a lossy environment comprises circuitry that initially transmits a data packet with a full header and subsequently transmits data packets with compressed headers. The compressed headers include information that details the differences between the subsequent packets and the original full packet. Accordingly, each subsequent packet has a header whose differences are based upon the original full header of the first packet. Accordingly, a base station transceiver system includes circuitry for transmitting and receiving data packets utilizing the described header compression algorithm. Similarly, a mobile terminal is formed to receive and transmit data packet headers compressed in this manner.

### CROSS REFERENCE TO RELATED APPLICATION

This application claims priority under 35 U.S.C. §119(b) to Provisional Application For Patent having an application Ser. No. 60/191,002 and filed on Mar. 21, 2000, entitled IP/UDP/RTP Header Compression Scheme for IP Real-Time Data in Wireless Lossy Environments, said application having the same three inventors listed herein.

### BACKGROUND

1. Technical Field

The present invention relates to communication networks, and more particularly, to a method and apparatus for compressing data packet headers to improve transmission efficiencies.

2. Related Art

Real time applications over lossy links having bandwidth constraints present design issues with competing interests. For example, that the link is a lossy link suggests that robust signal transmissions with significant overhead may improve accurate signal delivery. The types of mechanisms that improve signal delivery, however, require additional scarce communication resources. On the other hand, if transmission mechanisms are implemented that minimize the amount of scarce resources required to deliver the signal, then the information delivery is more subject to interference in a lossy environment. As a result of these design issues, there has been a great effort to develop methods of transmitting communication signals in a lossy environment that is both robust and maximally efficient.

As one example, designers have developed various header compression schemes for packets transmitted over a wireless interface. One common header compression technique includes transmitting a first full header and then, for a second header, transmitting a header that is compressed and that includes the differences between its full header information and that of the previously transmitted full header. Thereafter, a third header includes information that details the differences between the third and the second headers. The above described method for header compression is advantageous in that, for example, a 40 byte header may be reduced to 4 bytes in size in an optimal situation. The disadvantage to this scheme, however, is that an error in the transmission of the second header is propagated to the third, and then the fourth and all subsequent headers. What is needed, therefore, is a header compression scheme that achieves the efficiencies of known header compression schemes but that provides a more reliable and robust operation.

### SUMMARY OF THE INVENTION

A header compression scheme comprises a method and an apparatus that compresses headers with the same efficiency of other compression techniques but that achieves better reliability and robustness. More specifically, a full header is initially transmitted. Thereafter, the subsequent compressed header transmissions include signaling that identify the differences between the subsequent headers and the full header. Accordingly, any errors introduced in the transmission of a subsequent header does not affect any of the other subsequent headers because they are all based on differences with the full header instead of differences to the prior header transmission.

A base station transceiver system comprises circuitry for creating a first data packet having a full header and then for creating subsequent data packets whose headers are compressed in relation to the full header of the first data packet. More specifically, each of the compressed headers of the subsequent data packets defines the differences of the subsequent data packet header in relation the full header of the first data packet. Accordingly, by defining the differences, the original uncompressed header may be reconstructed because the full header values are known.

A mobile terminal formed according the present invention includes circuitry for receiving a data packet with a full header and then for receiving subsequent data packets having compressed headers and for recreating the headers of the subsequent data packets by examining the headers of the subsequent data packets in relation to the header of the first data packet having a full header.

Thus, once the mobile terminal recreates the headers it then processes the subsequent data packets with its internal circuitry. In the case of data packets representing audio for playback to the user through a speaker, the inventive mobile terminal reconstructs the original data packets with full headers and then generates the audio signals that are played from a speaker by audio processing circuitry for the user.

### BRIEF DESCRIPTION OF THE DRAWINGS

A better understanding of the present invention can be obtained when the following detailed description of the preferred embodiment is considered with the following drawings, in which:

FIGS. 1A and 1B are functional block diagrams that illustrate a communication network and a pair of data packets that illustrate aspects of the operation of a typical wireless data packet network.

FIG. 2 is a diagram that illustrates the relationships between a plurality of data packets using a prior art header compression scheme.

FIG. 3 is a diagram illustrating the relationship between a series of signals whose compression scheme is implemented according to the present invention.

FIG. 4 is a signal diagram illustrating a format of a data packet having a full header and the data packet having a compressed header.

FIG. 5 is a flow chart illustrating a method for compressing data packet headers according to one embodiment of the present invention.

FIG. 6 is a functional block diagram of a base station transceiver system formed according to one embodiment of the present invention.

FIG. 7 is a functional block diagram of a mobile terminal formed according to one embodiment of the present invention.

FIG. 8 is a flow chart illustrating the method for receiving and interpreting compressed headers according to one embodiment of the present invention.

FIG. 9 is a flow chart illustrating a method for processing received packets according to an embodiment of the present invention.

### DETAILED DESCRIPTION OF THE DRAWINGS

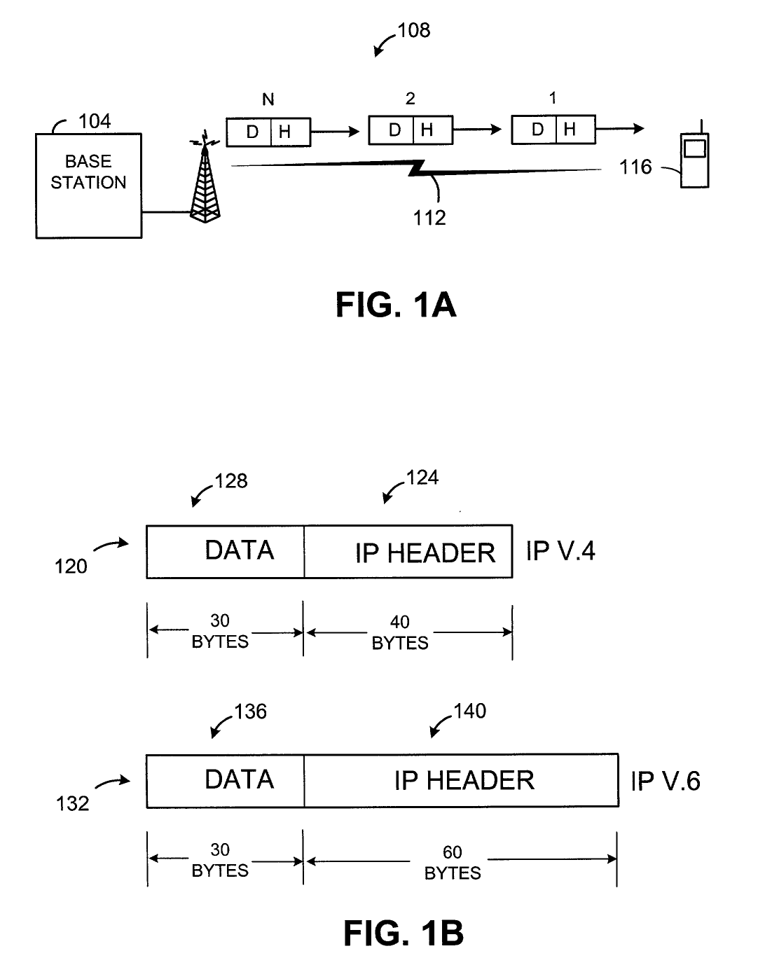

FIGS. 1A and 1B are functional block diagrams that illustrate a communication network and a pair of data packets that illustrate the operation of a typical wireless data packet network. Referring now to FIG. 1A, a base station transceiver system (BTS) 104 is coupled to transmit a plurality of data packets 108 by way of a wireless communication link 112 to a mobile terminal 116. As may be seen, each of the plurality of data packets 1-N contains a header portion and a data or payload portion. Ordinarily, each data packet comprises its own full header that includes all of the necessary header information for that data packet. The mobile terminal 116 then receives the data packet, analyzes the header information, and processes the data packet accordingly.

FIG. 1B illustrates a pair of typical data packets that might be transmitted as part of data packet stream 108. As may be seen, the data packet shown generally at 120 includes an IP header portion 124 and a data portion 128. In version 4 of defined IP protocol signaling formats, the IP header portion 124 is 40 bytes long while data portion 128 is 30 bytes long. As may be seen, the header portion is greater in length than the data portion. In version 6 of the IP signal formats and protocols, however, the IP header portion is even larger. As may be seen from referring signal 132, which represents a version 6 data packet, the data or payload portion 136 is still 30 bytes long while the IP header portion 140 is now 60 bytes long.

As was described previously, formats such as those seen in IP version 6, more specifically, data packet 132, support robust system operation. In a lossy environment, and in a wireless environment where resources are a premium, such overhead signaling consumes a very significant portion of the air resources thereby limiting the number of users at any given time. Accordingly, there is a significant need to reduce the signal size to increase capacity.

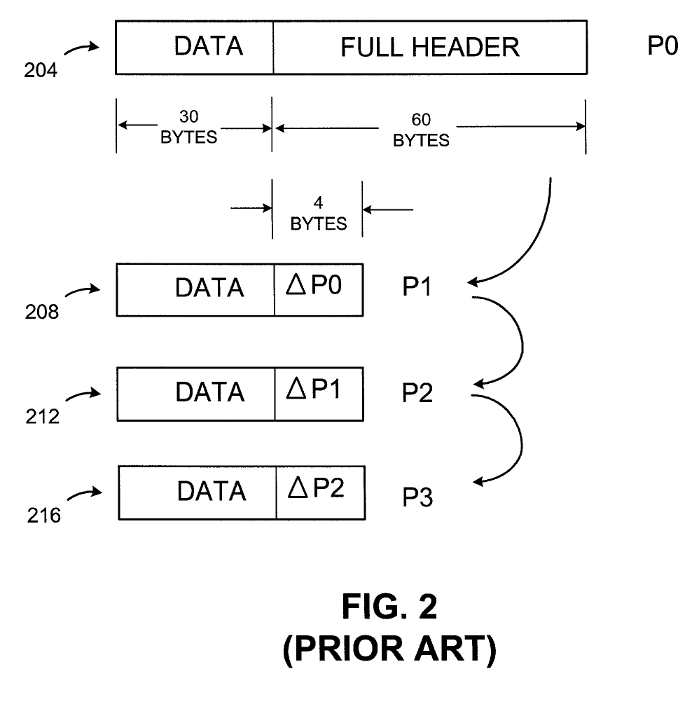

FIG. 2 is a diagram that illustrates the relationships between a plurality of data packets using a prior art header compression scheme. Referring to FIG. 2, packet P₀ shown generally at 204 comprises a full header that is 60 bytes long and a data portion that is 30 bytes long. Packet P₁, on the other hand, shown generally at 208, includes a header portion that is 4 bytes long and a data portion that is 30 bytes long. The header portion is formed using known header compression techniques. In one known header compression technique, a header is compressed using the header information of the previous data packet. Stated differently, the compressed header defines the differences between the header of the present signal and the header of the previous signal. Accordingly, in this example, the compressed header of packet P₁ defines the differences between it and the header of packet P₀. Similarly, the packet P₂ shown generally at 212 includes a header that is compressed and that defines the differences between it and the header of packet P₁. Finally, as shown in FIG. 2, the header of packet P₃ includes the differences found between its full header and the header of packet P₂.

In theory, the system of FIG. 2 works ideally because the headers may be compressed to only define the differences between a present header and a previous header thereby avoiding the transmission of unnecessary signaling. In theory, if an error occurs thereby impacting one or more headers, once an accurate header is received, the erroneous headers may be repaired and reconstructed. To do so, however, a robust coding algorithm such as a turbo coding algorithm is preferably used to facilitate data packet repair.

In a lossy environment, however, significant system resource becomes dedicated to repairing and to enabling the repair of headers. Additionally, headers are not as easily repaired as theory might suggest. Accordingly, a better header compression scheme is necessary. The problem becomes especially acute because, for example, if a transmission error occurs for packet P₁, then the packets P₂ and P₃ also are not properly reconstructed unless a robust and resource hungry coding scheme is used. For example, packet P₂ includes a header that defines the differences between it and the header of the previous packet P₁. If a robust coding scheme is not used, however, subsequent packets are affected if a packet is received in error. For example, if packet P₁ is received with errors packet P₂ cannot be properly reconstructed. Similarly, because packet P₂ cannot be properly reconstructed, packet P₃ cannot be properly reconstructed. As may be seen, therefore, the transmission error of one packet has a domino affect on the reconstruction of packets for subsequent packets. What is needed, therefore, is a system that achieves the same efficiencies of the header compression scheme of FIG. 2 but that avoids the domino affect that results from the erroneous receipt of a given data packet and that avoids a need for using robust coding on al data packets.

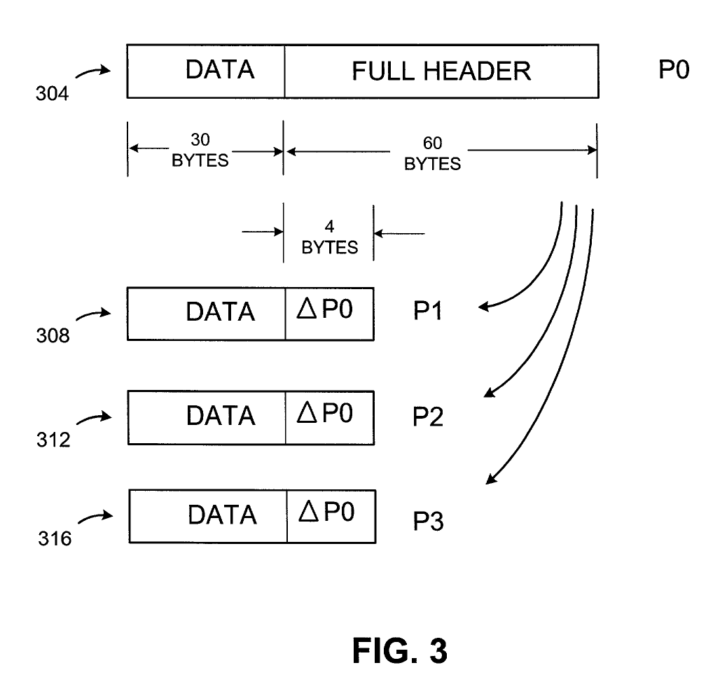

FIG. 3 is a diagram illustrating the relationship between a series of signals whose compression scheme is implemented according to the present invention. Initially, the packet P₀ shown generally at 304 is transmitted with a full header and a data portion. Thereafter, each of the subsequent packets P₁-P₃ shown at 308-316, respectively, includes a data portion and a compressed header portion. Here though, each of the packets P₁-P₃ has a compressed header portion that defines the differences between the header of the present packet and that of packet P₀. Accordingly, for example, an error in the transmission of packet P₁ will have no effect on the reconstruction of packets P₂ and P₃. The method for compressing each of the headers of packets P₁-P₃ on the transmission end, and for reconstructing the full headers of packets P₁-P₃ based upon a new full header includes known compression and decompression techniques. The difference between the present invention and prior art systems is that each of the compressed headers is based upon a full header P₀ and not upon a full header of the previously received or transmitted packet. Accordingly, a compressed packet received with errors may be discarded because its accurate reconstruction is not needed for the subsequent packets.

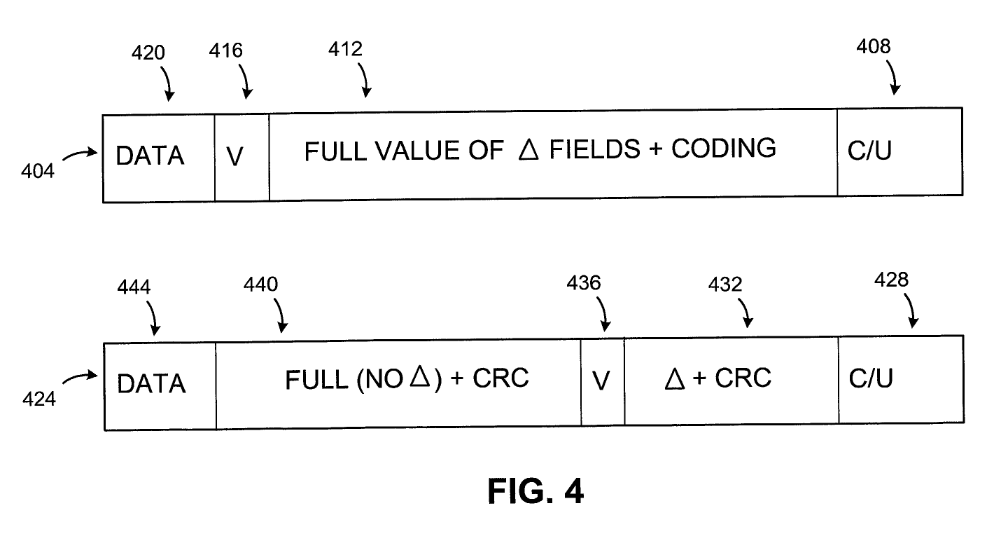

FIG. 4 is a signal diagram illustrating a format of a data packet having a full header and the data packet having a compressed header. A data packet shown generally at 404 includes a first portion 408 that is for defining whether the packet is a compressed packet or uncompressed packet. For example, a 1 might be used to indicate that the following packet is in a compressed format while a 0 might represent that it was transmitted in an uncompressed format. A second portion 412 then carries the full value of the header plus necessary coding. Here, a robust type of coding, such as turbo coding, is used to ensure the accurate delivery of the first packet.

A third portion 416 is for identifying the version of the IP protocol being used in formatting the data packet 404. For example, the IP protocol may be either IP v.4 or IP v.6. Finally, portion 420 is for carrying the actual data or payload of the data packet.

Data packet 424 is an example of the layout of subsequent compressed packets. Data packet 424 also includes a first portion 428 that identifies whether the packet is compressed or uncompressed. Here, in the present example, the data packet is compressed. Therefore, the logic state of the signal within portion 428 will be opposite of portion 408 of packet 404. A second portion 432 defines the differences between the header of packet 424 and packet 404 plus a check sum or CRC value for error detection purposes. As is known by those skilled in the art, the use of a CRC is for detecting errors but is not for facilitating the reconstruction of signals. As may be seen, the use of CRC instead of a sophisticated coding algorithm increases throughput, as less resources are required for implementing a reliable system that avoids the aforementioned domino effect.

Thereafter, a portion 436 is used to define the version of the IP protocol being used to format the packet. A portion 440 of packet 424 is for carrying bytes of information that cannot be compressed or whose differences cannot be defined with relation to the header of packet 404. Thus, portion 440 includes the full header information plus its CRC for those portions that cannot be compressed. Finally, portion 444 of data packet 424 is for carrying the data.

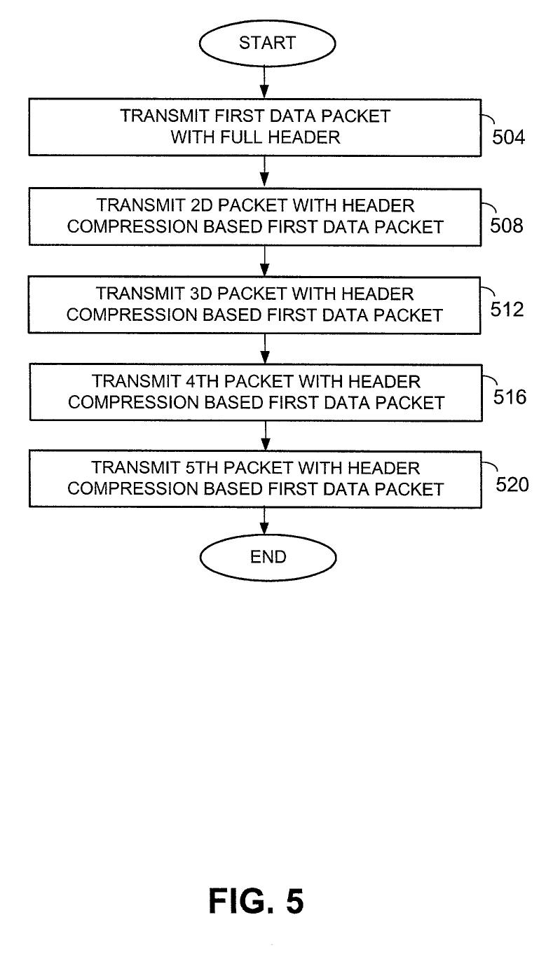

FIG. 5 is a flow chart illustrating a method for compressing data packet headers according to one embodiment of the present invention. Initially, a base station transceiver system transmits a data packet with a full header (step 504). Thereafter, each of the subsequent packets is transmitted having headers that are compressed with differences that define differences from this first full header. Thus, the next step of the invention is to transmit a second packet with a compressed header whose differences are based on the first full header of the first packet (step 508). Thereafter, a third packet is transmitted with a compressed header whose differences are based on the first full header of the first packet (step 512). Thereafter, a fourth packet is transmitted with a compressed header whose differences are based on the first full header of the first packet (step 516). Thereafter, a fifth packet is transmitted with a compressed header whose differences are based on the first full header of the first packet (step 520).

As may be seen, the method may be repeated multiple times. One advantage of the present invention is that the domino effect of errors is circumvented, as described before. A second benefit is that less coding is required and a need to reconstruct erroneously received headers is reduced or eliminated because one erroneous header does not affect subsequent header reconstruction.

Given the present inventive scheme, it is important for the first full header of the first packet to be received accurately. Therefore, going back to step 504, in one embodiment of the present invention, the first packet is transmitted with a high level of coding and error correction to insure that the header is received accurately. Thereafter, lower forms of coding may be used for the subsequent headers since there is not a domino effect with the errors. Accordingly, a header received in error may result in the packet being discarded without severe effects on the communication. The header compression may approach four bytes in size, which, significantly improves through put capacity without introducing strings of errors.

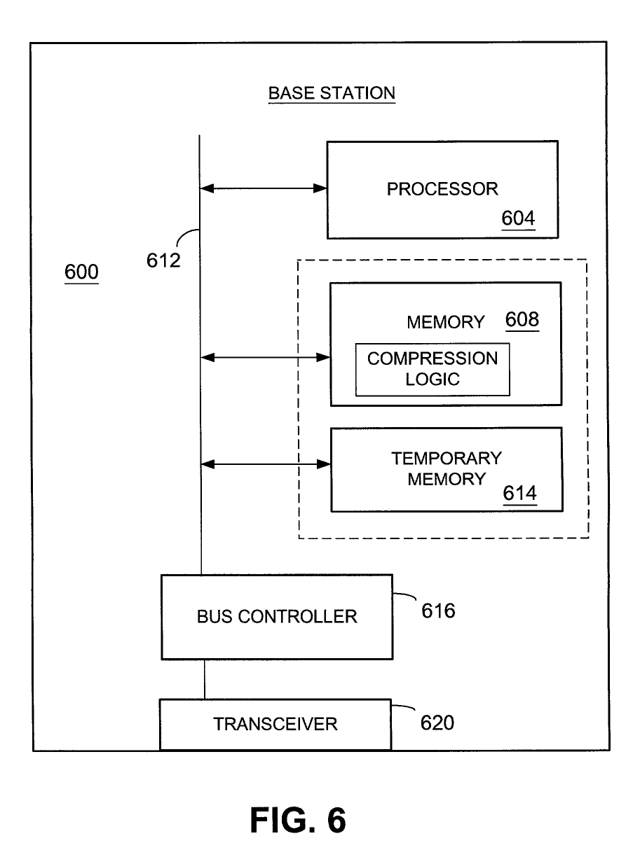

FIG. 6 is a functional block diagram of a base station transceiver system formed according to one embodiment of the present invention. Referring now to FIG. 6, a BTS 600 includes a processor 604 that is coupled to receive computer instructions stored within a memory 608 by way of an internal bus 612. Internal bus 612 is coupled to and controlled by a bus controller 616. Bus controller 616 further is coupled to a transceiver 620 for receiving and transmitting communication signals. Memory 608 further comprises computer instructions that define system operation, and more particularly, the compression algorithms of the present invention. Thus, the computer instructions stored within memory 608 define the operational logic that cause the BTS 600 to compress the data packet headers as described herein this application and in the described methods.

In operation, therefore, processor 604 receives computer instructions stored within memory 608 that it executes to cause BTS 600 to transmit a data packet with a full header from transceiver 620 and thereafter, compressed headers whose differences are measured against the full header of the first data packet. While not shown explicitly herein FIG. 6, transceiver 620 is coupled to an antenna for transmitting the packets over a wireless link. Thus, it should be understood, that memory 608 further includes computer instructions that define logic for traditional BTS operation. While the system of FIG. 6 illustrates an implementation that includes a combination of software and hardware, the system may also be formed exclusively in hardware as is known by those skilled in the art.

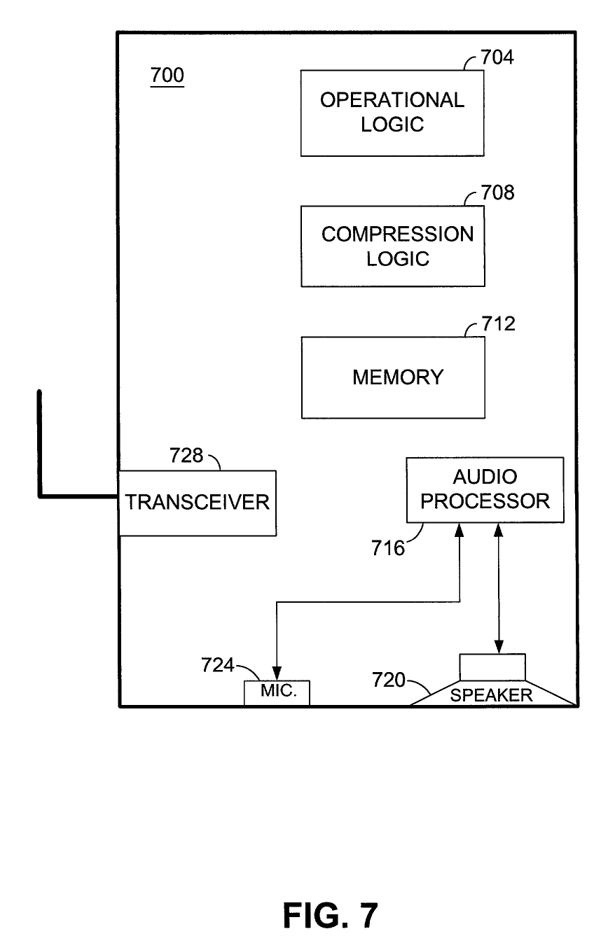

FIG. 7 is a functional block diagram of a mobile terminal formed according to one embodiment of the present invention. Referring now to FIG. 7, a mobile terminal 700 comprises logic circuitry that defines routine mobile terminal operation in module 704. Additionally, mobile terminal 700 comprises a compression logic module 708 that defines the described and claimed compression logic. Accordingly, when mobile terminal 700 receives communication signals having compressed headers, which compressed headers are compressed according to the inventive scheme, the compression logic 708 enables mobile terminal 700 to decompress or reformulate the original headers for processing by operational logic module 704.

Mobile terminal 700 further comprises memory 712 for temporarily storing communication signals and data to perform the functionality of mobile terminal 700. Additionally, mobile terminal 700 includes an audio processor 716 that is coupled to play audio over a speaker 720 and to receive audio signals from a microphone 724. Additionally, mobile terminal 700 includes a transceiver 728 that is coupled to an antenna to receive and transmit wireless communication signals.

The mobile terminal 700 of FIG. 7 illustrates a terminal that has been formed in hardware with application specific integrated circuits. It is understood, of course, that mobile terminal 700 also may be formed to include a processor and an internal bus and a memory that includes computer instructions that define the operational logic of the mobile terminal 700.

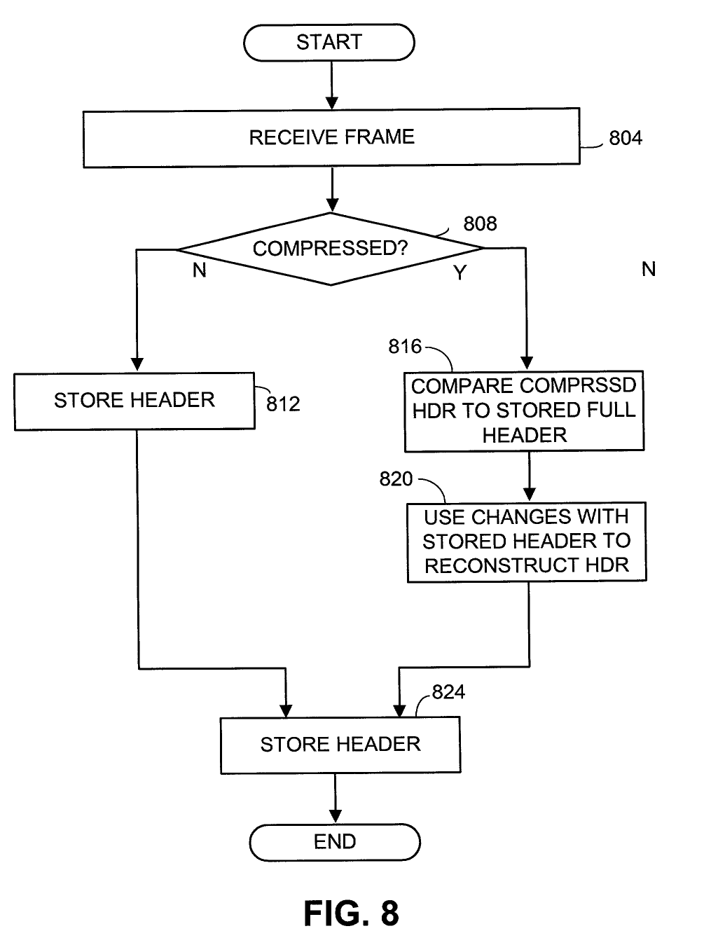

FIG. 8 is a flow chart illustrating the method for receiving and interpreting compressed headers according to one embodiment of the present invention. Initially, the inventive process includes receiving a data packet (step 804). Thereafter, the system determines the type of packet that was transmitted in a compressed or uncompressed (Full) format (step 808). If a packet with a full header was transmitted, then the header is stored (step 812). If a compressed header was transmitted, the compressed header is compared to the full header (step 816). Thereafter, the compressed header, more particularly, the changes from the full header, as defined in the compressed header, are used to reconstruct the full header for the received data packet (step 820). Once the full data packet has been reconstructed in step 820 or after it has been stored in step 812, the signal is processed in a routine manner (step 824). The above method steps may be performed either by a mobile terminal or by a base station transceiver system.

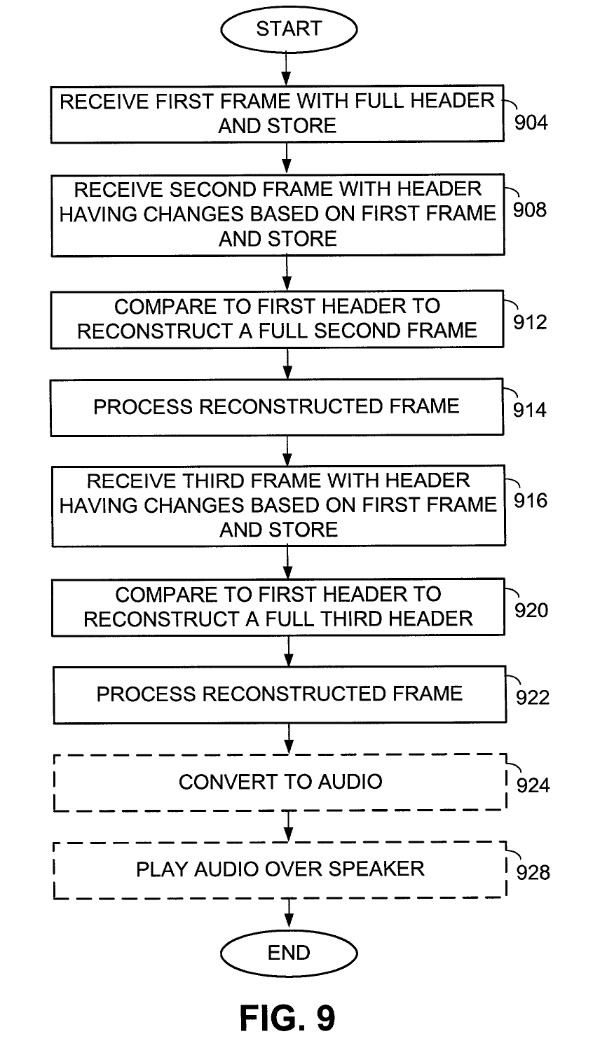

FIG. 9 is a flow chart illustrating a method for processing received data packets according to an embodiment of the present invention. The method is performed in a receiver, which receiver can comprise either a base station transceiver system or a mobile terminal. Initially, the receiver receives a full header and stores the same (step 904). Thereafter, it receives a second header (step 908) and compares the changes in the second header to the full header to reconstruct the header of the second packet (step 912). The reconstructed packet is then processed (step 914).

Thereafter, the receiver receives and stores a third header, which header is compressed and specifies changes relative to the full header of the first data packet (step 916) and compares the third compressed header differences to the full header of the first packet (that was previously stored) to reconstruct the header of the third packet (step 920). Thereafter, the reconstructed packet is processed using conventional processing techniques (step 922). If the receiver is a mobile terminal, then the received packets are reconstructed and converted to audio by an audio processor (step 924) and are produced to a speaker for playback to the user (step 928).

The inventive method and apparatus disclosed herein are particularly advantageous in that they provide a capability for efficient packet header compression in a manner that reduces the need for sophisticated coding that is required to avoid the aforementioned domino effect resulting from erroneous header transmissions.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method for transmitting data packets in a lossy environment, comprising:
transmitting a first data packet with a full header;
transmitting a second data packet with a compressed header, which compressed header includes differences based upon the full header of the first data packet; and
transmitting a third data packet with a compressed header, the compressed header of the third data packet including differences in the header of the third data packet as compared to the first data packet.

2. The method of claim 1 further including the step of transmitting a fourth data packet, the fourth data packet having a compressed header whose differences are based upon the first signals' full header.

3. A method for receiving and interpreting data packets, comprising receiving a first data packet having a full header;
receiving a second data packet having a compressed header whose differences are based upon the full header of the first packet; and
receiving a third data packet having a compressed header, which compressed header is based upon differences with the full header of the first data packet.

4. The method of claim 3, further including the step of receiving a fourth data packet having a compressed header based upon the full header of the first data packet.

5. The method of claim 3, further comprising the step of receiving a data packet with errors, and upon determining that the data packet has errors, discarding the data packet.

6. A system for transmitting data packets, comprising:
a memory for storing computer instructions that define compression logic, which compression logic causes compressed data packets to be formed with differences that are measured against a full and uncompressed data packet; and
a processor coupled to receive and execute the computer instructions stored within the memory to cause the system to operate in a manner defined by the logic of the computer instructions.

7. The system of claim 6, further including an internal bus coupled to the memory and to the processor to enable the processor to receive the computer instructions from the memory.

8. The system of claim 6 further including transceiver circuitry for transmitting data packets over a wireless interface.

9. A system for receiving compressed data packets, comprising transceiver circuitry for receiving the data packets, which data packets are transmitted over an air interface;
processing circuitry for reconstructing the data packets that are received in a compressed format, which compressed format includes packet header information whose differences are based upon a specified full and uncompressed packet header; and
audio processing circuitry for converting communication signals to sound signals to communication signals.

10. The receiver of claim 9, further including logic circuitry for determining whether a packet was received in a compressed or uncompressed format.

11. The receiver of claim 10, wherein the logic circuitry is formed to reconstruct a packet header based upon defined differences specified within the compressed header and a specified full header wherein the specified full header is used as a basis for each of a plurality of subsequently transmitted packets having compressed headers.

12. A plurality of communication signals, comprising a first communication signal transmitted in an uncompressed format having a full header;
a second communication signal having a compressed header, which compressed header specifies differences between its header in an uncompressed format and the full header of the first data packet; and
a third communication signal having a compressed header, which compressed header specifies differences between a full header for the third communication signal and the full header of the first communication signal.

13. The communication signals of claim 12, wherein the second and third communication signals further include uncompressed header information for those portions of a header that could not be compressed and for which differences with the full header of the first communication signal could not be specified.

14. The communication signals of claim 13, further comprising a byte for specifying whether the communication signal has a compressed or uncompressed header.

15. The communication signal of claim 13, further comprising at least one byte for identifying the Internet protocol version format that defines the signal layout.
